(19) United States
(12) Patent Application Publication
(10) Pub. No.: US 2026/0088899 A1
(43) Pub. Date: Mar. 26, 2026

(54) OPTICAL TRANSMISSION SYSTEM AND OPTICAL TRANSMISSION DEVICE

(71) Applicant: 1FINITY Inc., Kawasaki-shi (JP)

(72) Inventors: Shota MORI, Yokohama (JP); Yoshito KACHITA, Kawasaki (JP); Yusaku YAMAMOTO, Kawasaki (JP); Takashi SATO, Kawasaki (JP)

(73) Assignee: 1FINITY Inc., Kawasaki-shi (JP)

(21) Appl. No.: 19/327,737

(22) Filed: Sep. 12, 2025

(30) Foreign Application Priority Data
Sep. 20, 2024 (JP) 2024-164088

(51) Int. Cl. H04B 10/077; H04B 10/071; H04B 10/25; H04B 10/291; H04B 10/50; H04B 10/564

(52) U.S. Cl. CPC H04B 10/0779; H04B 10/071; H04B 10/25891; H04B 10/2916; H04B 10/506; H04B 10/564

(57) ABSTRACT

An optical transmission system includes a first optical transmission device that transmits an OSC (Optical Supervisory Channel) light to an optical transmission line, and a second optical transmission device that receives for receiving the OSC light from the optical transmission line. The first optical transmission device includes a first controller that detects a transmission line disconnection before communication with the OSC light is established in the optical transmission line, based on a first detection method, and a second optical transmission device including a second controller that detects a transmission line disconnection after the communication with the OSC light is established in the optical transmission line, based on a second detection method different from the first detection method.

### CROSS-REFERENCE TO RELATED APPLICATION

This application is based upon and claims the benefit of priority of the prior Japanese Patent Application No. 2024-164088, filed on Sep. 20, 2024, the entire contents of which are incorporated herein by reference.

### FIELD

A certain aspect of embodiments described herein relates to an optical transmission system and an optical transmission device.

### BACKGROUND

There is known an optical transmission system for transmitting a WDM (Wavelength Division Multiplexing) signal light including a plurality of optical signals having different wavelengths. There is also known an optical transmission system in which an optical repeater using an optical amplifier amplifies a signal light, and relays and transmits the amplified signal light (see, for example, Japanese Patent Application Laid-Open No. 2003-124889).

An optical transmission system includes an optical transmission device and an optical reception device. The optical transmission device and the optical reception device actually have the same function as one optical transmission device. For example, an optical transmission device is provided with an optical amplifier for amplifying and outputting signal light. In addition, in an optical transmission system, an optical supervisory signal called an OSC (Optical Supervisory Channel) is used for operation setting, condition monitoring, and the like (see, for example, Japanese Patent Application Laid-Open No. 2004-088376, U.S. Pat. No. 10,992,374, or U.S. Patent Application Publication No. 2006/0140626).

### SUMMARY

According to an aspect of the embodiments, there is provided an optical transmission system including a first optical transmission device that transmits an OSC (Optical Supervisory Channel) light to an optical transmission line, and a second optical transmission device that receives the OSC light from the optical transmission line, the first optical transmission device including a first controller that detects a transmission line disconnection before communication with the OSC light is established in the optical transmission line, based on a first detection method, and the second optical transmission device including a second controller that detects a transmission line disconnection after the communication with the OSC light is established in the optical transmission line, based on a second detection method different from the first detection method.

The object and advantages of the invention will be realized and attained by option of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a block diagram showing an example of an optical transmission system according to a first embodiment.

FIG. 2 is a flowchart showing an example of the operation of the optical transmission system according to the first embodiment.

FIGS. 3A to 3F are diagrams for explaining an example of the operation of the optical transmission system.

FIGS. 4A to 4D are diagrams for explaining another example of the operation of the optical transmission system.

FIG. 5 is a diagram for explaining an example of the optical operation of the comparative example of the optical transmission system according to the first embodiment.

FIG. 6 is a diagram for explaining an example of the optical operation of the optical transmission system according to the first embodiment.

FIG. 7 is a block diagram showing an example of an optical transmission system according to a second embodiment.

FIG. 8 is a flowchart showing an example of the operation of the optical transmission system according to the second embodiment.

FIG. 9 is a diagram for explaining an example of the optical operation of the comparative example of the optical transmission system according to the second embodiment.

FIG. 10 is a diagram for explaining an example of an optical operation according to an embodiment of the optical transmission system according to the second embodiment.

FIG. 11 is a block diagram showing an example of an optical transmission system according to a third embodiment.

FIG. 12 is a flowchart showing an example of the operation of the optical transmission system according to the third embodiment.

### DESCRIPTION OF EMBODIMENTS

When the span loss of the optical transmission line interposed between the optical transmission devices facing each other is excessive, it becomes difficult to transmit the OSC light between the optical transmission devices depending on the optical power of the optical monitoring signal (hereinafter referred to as OSC light). In this case, there is a possibility that the optical transmission device cannot confirm the communication of the OSC light when the optical transmission device is started. When the optical transmission device cannot confirm the communication of the OSC light, for example, a method of increasing the optical power of the OSC light by using a pseudo light called a pseudo wave to thereby make the communication is assumed.

However, when the pseudo light is used, if a transmission line break occurs in the optical transmission line, the pseudo light having a large optical power is radiated from the optical transmission line, and it becomes difficult to perform a safe restoration work for the optical transmission line. That is, if the transmission line of the optical transmission line is cut off before the OSC light is transmitted, there is a possibility that the safety for the restoration work of the optical transmission line cannot be ensured.

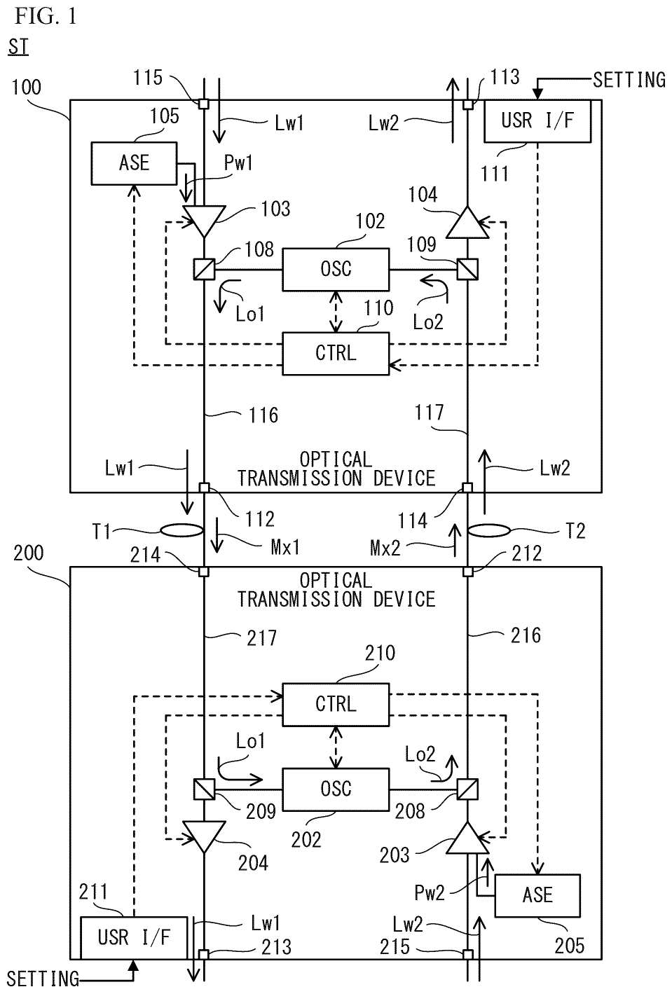

Hereinafter, embodiments will be described in detail with reference to FIG. 1 to FIG. 12.

(First Embodiment) As shown in FIG. 1, an optical transmission system ST includes two optical transmission devices 100 and 200, which face each other. The optical transmission device 100 is an example of a first optical transmission device. The optical transmission device 200 is an example of a second optical transmission device. Each of the optical transmission devices 100 and 200 includes, for example, a reconfigurable optical add/drop multiplexer (ROADM).

The optical transmission devices 100 and 200 are connected to each other through two optical transmission lines T1 and T2 arranged in parallel. One end of each of the optical transmission lines T1 and T2 is connected to the optical transmission device 100. The other end of each of the optical transmission lines T1 and T2 is connected to the optical transmission device 200. The optical transmission lines T1 and T2 both include optical fibers. The type of the optical fibers is not particularly limited. The optical fibers may be an SMF (Single Mode Fiber) or a DSF (Dispersion Shifted Fiber).

First, the optical transmission device 100 will be described. The optical transmission device 100 includes an OSC input/output unit 102, optical amplifiers 103 and 104, and an amplified spontaneous emission (ASE) light source 105. The optical transmission device 100 includes a WDM coupler 108, a branch coupler 109, and a controller (denoted as CTRL in FIG. 1) 110. The branch coupler 109 may be a WDM coupler. The controller 110 is an example of a first controller. The ASE light source 105 is an example of a pseudo light source.

The optical transmission device 100 further includes a user interface (denoted as USR I/F in FIG. 1) 111, optical transmission units 112 and 113, and optical reception units 114 and 115. Each of the optical transmission units 112 and 113 and the optical reception units 114 and 115 includes a respective optical connector. The optical amplifier 103, the WDM coupler 108, the optical transmission unit 112, and the optical reception unit 115 are provided on an optical transmission path 116 of the optical transmission device 100. The optical amplifier 104, the branch coupler 109, the optical transmission unit 113, and the optical reception unit 114 are provided on an optical transmission path 117 of the optical transmission device 100. The optical transmission paths 116 and 117 may be optical fibers.

The OSC input/output unit 102 is optically connected to the WDM coupler 108 and the branch coupler 109. The OSC input/output unit 102 outputs an OSC light Lo1 directed to the optical transmission device 200. The OSC light Lo1 may or may not include a loss value (hereinafter referred to as a span loss) of the optical transmission line T1. The OSC input/output unit 102 receives an OSC light Lo2 output from the optical transmission device 200. The OSC light Lo2 may or may not include the span loss of the optical transmission line T2. Furthermore, when a transmission line disconnection occurs in the optical transmission line T1, a return light that returns by reflection of the OSC light Lo1 may be input to the OSC input/output unit 102. The transmission line disconnection includes, for example, disconnection of a connector or a fiber.

The optical amplifier 103 amplifies and outputs a WDM signal light Lw1 received by the optical transmission device 100 via the optical reception unit 115 and a pseudo light Pw1 described later. That is, the optical amplifier 103 increases the optical power of the WDM signal light Lw1 and the pseudo light Pw1 and outputs the increased optical power. The optical amplifier 103 is a post-amplifier realized by, for example, an EDFA (Erbium Doped Fiber Amplifier) and a circuit board for controlling the gain of the EDFA.

The post-amplifier is provided at a stage subsequent to or downstream from a WSS (Wavelength Selective Switch) (not shown) provided between the optical amplifier 103 and the ASE light source 105. The WDM signal light Lw1 output from the optical amplifier 103 is transmitted to the optical transmission line T1 via the optical transmission unit 112.

The optical amplifier 104 amplifies and outputs a WDM signal light Lw2 received by the optical transmission device 100 via the optical reception unit 114 and the pseudo light Pw2 described later. The optical amplifier 104 is a preamplifier realized by, for example, an EDFA and a circuit board for controlling the gain of the EDFA. The preamplifier is an amplifier provided in the front stage or upstream of a WSS (not shown) provided between the optical amplifier 104 and the optical transmission unit 113. The WDM signal light Lw2 output from the optical amplifier 104 is transmitted through the optical transmission unit 113.

The ASE light source 105 is optically connected to the optical amplifier 103. More specifically, the ASE light source 105 is indirectly connected to the optical amplifier 103 through the WSS described above. The ASE light source 105 outputs a pseudo light Pw1 called a pseudo wave, for example. The pseudo light Pw1 includes a wavelength band of the WDM signal light Lw1, such as a C-band (Conventional-band) or an L-band (Long-wavelength-band). It is noted that the C band is a wavelength band of, for example, 1530 nm to 1565 nm. The L band is a wavelength band of, for example, 1565 nm to 1625 nm.

The pseudo light Pw1 is amplified by the optical amplifier 103. After amplification, the pseudo light Pw1 is multiplexed with the OSC light Lo1 by the WDM coupler 108. Thus, multiplexed light Mx1 is generated by multiplexing the OSC light Lo1 and the pseudo light Pw1. The optical transmission unit 112 transmits the multiplexed light Mx1 to the optical transmission device 200. Thus, the multiplexed light Mx1 propagates through the optical transmission line T1.

The controller 110 is electrically connected to the OSC input/output unit 102, the optical amplifiers 103 and 104, the ASE light source 105, and the user interface 111. The controller 110 includes a processor such as a CPU (Central Processing Unit) and a memory such as a RAM (Random Access Memory) or a ROM (Read Only Memory). The controller 110 may include a field programmable gate array (FPGA) or an application specific integrated circuit (ASIC).

The controller 110 controls the operation of the OSC input/output unit 102, the optical amplifiers 103 and 104, and the ASE light source 105. For example, the controller 110 can request the OSC input/output unit 102 to output the OSC light Lo1. The controller 110 can instruct the ASE light source 105 to output the pseudo light Pw1. The controller 110 can adjust the gain of the optical amplifiers 103 and 104.

The controller 110 can measure the span loss of the optical transmission line T1 based on the optical power of the optical light output from the optical transmission device 100 to the optical transmission line T1 and the optical power of the reflected light of the optical light. The span loss of the optical transmission line T1 may be prepared in advance without measuring the span loss. Then, the controller 110 acquires setting information including, for example, the span loss of the optical transmission line T1 from the user interface 111 at the start of the activation of the optical transmission device 100 before the operation of the optical transmission system ST is started. That is, the controller 110 acquires the setting information before the communication of the WDM signal lights Lw1 and Lw2 is started. When the controller 110 determines that the span loss is excessive based on the setting information, the controller 110 switches the start mode based on the setting of the start mode from the user via the user interface 111. Specifically, the controller 110 determines that the span loss is excessive when the span loss is equal to or greater than a predetermined value to be compared. When the span loss is too large, the controller 110 switches the mode from the normal mode in which the pseudo light Pw1 is not output to an extended mode in which the pseudo light Pw1 is output.

Next, the optical transmission device 200 will be described. The optical transmission device 200 includes an OSC input/output unit 202 and optical amplifiers 203 and 204. The optical transmission device 200 includes an ASE light source 205, a WDM coupler 208, a branch coupler 209, and a controller 210. The controller 210 is an example of a second controller. The optical transmission device 200 further includes a user interface 211, optical transmission units 212 and 213, and optical reception units 214 and 215.

The optical amplifier 203, the WDM coupler 208, the optical transmission unit 212, and the optical reception unit 215 are provided on an optical transmission path 216 of the optical transmission device 200. The optical amplifier 204, the branch coupler 209, the optical transmission unit 213, and the optical reception unit 214 are provided on an optical transmission path 217 of the optical transmission device 200.

As described above, the optical transmission device 200 basically has a similar configuration as that of the optical transmission device 100. Therefore, the details of the optical transmission device 200 are omitted. For example, the OSC input/output unit 202 outputs the OSC light Lo2 directed to the optical transmission device 100. The ASE light source 205 outputs the pseudo light Pw2 including the wavelength band of the WDM signal light Lw2, such as the C band or the L band. The optical transmission unit 212 transmits a multiplexed light Mx2 obtained by multiplexing the OSC light Lo2 and the pseudo light Pw2 to the optical transmission device 100. Thus, the multiplexed light Mx2 propagates through the optical transmission line T2.

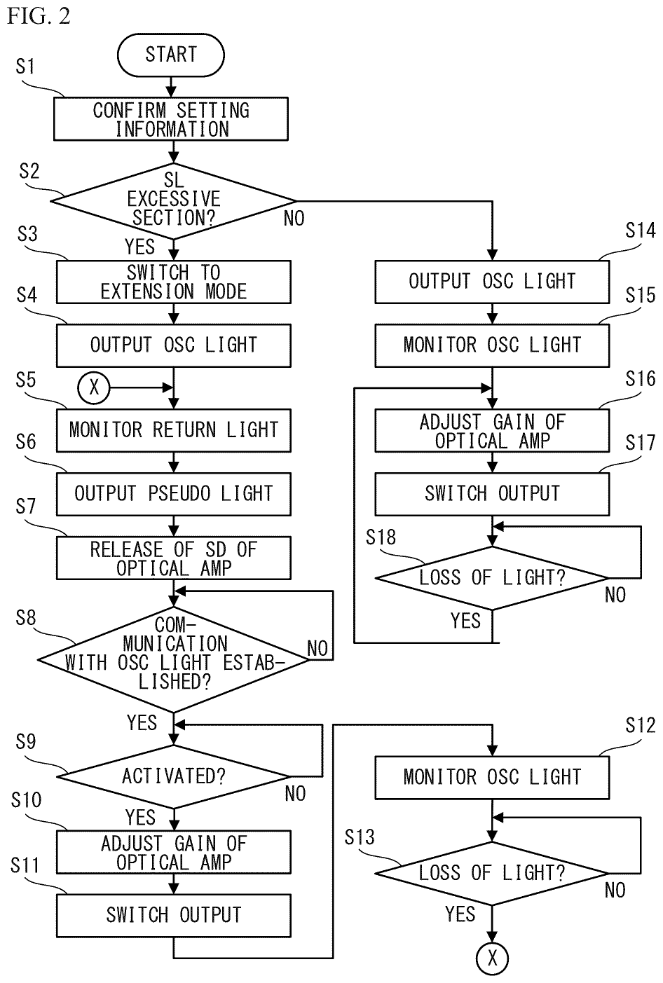

Referring to FIGS. 2 to 6, the operation of the optical transmission system ST according to the first embodiment will be described. The controllers 110 and 210 basically execute the similar processing. Therefore, the processing executed by the controller 110 will be described as an example, and the processing executed by the controller 210 will be described as necessary.

When the predetermined setting information is provided to the optical transmission device 100 from the user, the controller 110 acquires and confirms the setting information (step S1). The setting information includes, for example, a span loss of the optical transmission line T1 and a transmission line length of the optical transmission line T1. Before the processing of step S1, as described above, the controller 110 may measure the span loss of the optical transmission line T1 based on the optical power of the optical light output from the optical transmission device 100 to the optical transmission line T1 and the optical power of the reflected light. When the setting information is confirmed, the controller 110 determines whether or not the optical transmission line T1 is a span loss excessive section (denoted as an SL excessive section in FIG. 2) based on the setting information (step S2).

When the optical transmission line T1 is in the span loss excessive section (step S2: YES), the controller 110 switches the start mode to the extension mode based on the setting of the start mode from the user (step S3). When the mode is switched to the extension mode, the controller 110 requests the OSC input/output unit 102 to output the OSC light Lo1 (step S4).

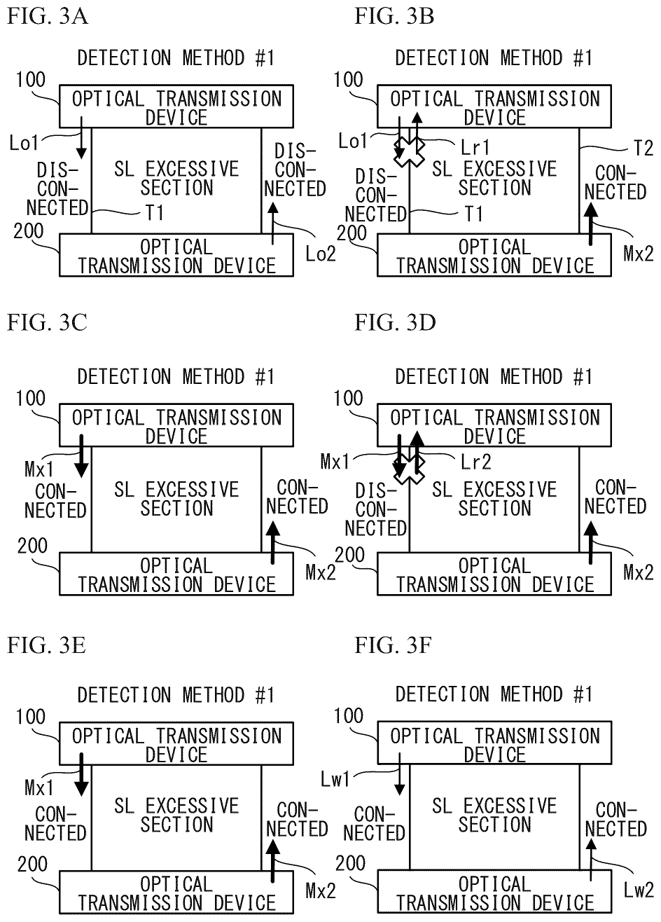

Thus, the OSC input/output unit 102 outputs the OSC light Lo1 with the maximum optical power (specifically, about several dBm). Therefore, as shown in FIG. 3A, the optical transmission device 100 including the OSC input/output unit 102 outputs the OSC light Lo1 with the maximum optical power. Similarly, the OSC input/output unit 202 outputs the OSC light Lo2 with the maximum optical power. Therefore, as shown in FIG. 3A, the optical transmission device 200 including the OSC input/output unit 202 outputs the OSC light Lo2 with the maximum optical power.

However, the optical transmission line T1 corresponds to a span loss excessive section. Therefore, even if the OSC light Lo1 is output at the maximum optical power, the OSC light Lo1 cannot reach the optical transmission device 200 by itself due to the shortage of the optical power. As a result, the OSC light Lo1 is interrupted. The OSC light Lo2 is also interrupted for the same reason as the OSC light Lo1.

When the OSC light Lo1 is output at the maximum optical power, the controller 110 monitors the return light as shown in FIG. 2 (step S5). For example, as shown in FIG. 3B, when a transmission line break occurs in the optical transmission line T1, the return light Lr1 of the OSC light Lo1 is input to the optical transmission device 100 due to the Fresnel reflection at the position where the transmission line break occurs. More specifically, the return light Lr1 is input to the OSC input/output unit 102 included in the optical transmission device 100.

The controller 110 monitors the OSC input/output unit 102 and determines whether or not the return light Lr1 is input to the OSC input/output unit 102. When the return light Lr1 is input to the OSC input/output unit 102, the controller 110 measures the optical power of the return light Lr1. If the measured optical power is equal to or greater than the threshold value, the controller 110 determines that a transmission line disconnection has occurred in the optical transmission line T1. When the controller 110 determines that a transmission line disconnection has occurred, the controller 110 requests the optical amplifier 103 to cancel the release from the shutdown. As a result, the optical amplifier 103 maintains the shutdown state.

Thus, the optical amplifier 103 can block the transmission of the pseudo light Pw1. Therefore, the multiplexed light Mx1 including the pseudo light Pw1 is not generated, and the OSC light Lo1 is output from the optical transmission device 100 alone. In this way, the controller 110 detects the transmission line disconnection of the optical transmission line T1 based on the first detection method for detecting the optical power equal to or greater than the threshold value of the return light Lr1 of the OSC light Lo1.

Here, the optical power of the OSC light Lo1 is smaller than the optical power of the multiplexed light Mx1. This is because the multiplexed light Mx1 includes not only the OSC light Lo1 but also the pseudo light Pw1. Even if the OSC light Lo1 is output to the optical transmission line T1 with the maximum optical power, since the optical power is small, the safety in the recovery operation of the optical transmission line T1 can be improved as compared with the case where the multiplexed light Mx1 is output from the optical transmission device 100. In this way, the output of the pseudo light Pw1 is cut off, so that the restoration work is safely performed. When the controller 110 detects a transmission line disconnection of the optical transmission line T1, the controller may stop the output of the OSC light Lo1 from the optical transmission device 100.

On the other hand, the return light Lr1 is monitored, and if the return light Lr1 is not input to the OSC input/output unit 102, the controller 110 instructs the output of the pseudo light Pw1 (step S6) and requests the release from the shutdown (indicated as SD in FIG. 2) of the optical amplifier 103 (step S7), as shown in FIG. 2. As a result, the ASE light source 105 outputs the pseudo light Pw1, and the optical amplifier 103 allows the pseudo light Pw1 to pass through.

Thus, the multiplexed light Mx1 including the pseudo light Pw1 is generated, and the multiplexed light Mx1 is output from the optical transmission device 100. For example, as shown in FIG. 3B, if no transmission line disconnection occurs in the optical transmission line T2, no return light is generated and the multiplexed light Mx2 is output from the optical transmission device 200.

Even if the optical transmission line T2 corresponds to the span loss excessive section, the optical power of the multiplexed light Mx2 is larger than the optical power of the OSC light Lo2 alone, and therefore the multiplexed light Mx2 propagates through the optical transmission line T2. Thus, the OSC light Lo2 included in the multiplexed light Mx2 reaches the optical transmission device 100. That is, the communication of the OSC light Lo1 is interrupted in the optical transmission line T1, and the communication of the OSC light Lo2 is opened in the optical transmission line T2. In other words, one way communication indicating communication of either the OSC light Lo1 or Lo2 is established.

As shown in FIG. 2, the controller 110 waits until the OSC light Lo1 and the OSC light Lo2 communicate with each other (step S8: NO). That is, the controller 110 waits until the communication of the OSC lights Lo1 and Lo2 is opened in both the optical transmission lines T1 and T2. In other words, the controller 110 waits until the communication indicating the bidirectional communication between the OSC lights Lo1 and Lo2 is established.

For example, when the restoration work of the optical transmission line T1 is completed, the return light Lr1 is not generated, and the multiplexed light Mx1 is output from the optical transmission device 100 as shown in FIG. 3C. When the multiplexed light Mx1 is output, the multiplexed light Mx1 propagates through the optical transmission line T1. Thus, the OSC light Lo1 included in the multiplexed light Mx1 reaches the optical transmission device 200. When the OSC light Lo1 reaches the optical transmission device 200, the OSC lights Lo1 and Lo2 are communicated (step S8: YES).

As will be described in detail later, when the multiplexed light Mx1 propagates through the optical transmission line T1, stimulated Raman scattering occurs, and the optical power of the pseudo light Pw1 included in the multiplexed light Mx1 transits to the OSC light Lo1. This is because the wavelength of the OSC light Lo1 is longer than that of the pseudo light Pw1. Thus, even if the optical power of the OSC light Lo1 is increased and the optical transmission line T1 corresponds to the span loss excessive section, the OSC light Lo1 can reach the optical transmission device 200 from the optical transmission device 100.

Here, when a transmission line break occurs in the optical transmission line T1 as shown in FIG. 3D in a state where the OSC light Lo1 and the OSC light Lo2 are communicated, there is a possibility that the multiplexed light Mx1 is radiated from the optical transmission line T1 at a position where the transmission line break occurs. In particular, when the transmission line is disconnected inside the station where the optical transmission device 100 is installed, the optical power of the multiplexed light Mx1 may be larger than when the transmission line is disconnected outside the station. This is because the optical power of the multiplexed light Mx1 is attenuated as the distance from the station house increases.

When the transmission line break occurs in the optical transmission line T1 in the state where the OSC light Lo1 and the OSC light Lo2 are communicated in this way, the return light Lr2 of the multiplexed light Mx1 is input to the optical transmission device 100 due to the Fresnel reflection at the position where the transmission line break occurs. More specifically, the return light Lr2 is input to the OSC input/output unit 102 included in the optical transmission device 100.

The return light Lr2 includes not only the return light Lr1 of the OSC light Lo1 but also noise light caused by the pseudo light Pw1. As will be described in detail later, when the OSC light Lo1 is not output at the maximum optical power, the optical power of the return light Lr1 is reduced as compared with the case where the OSC light Lo1 is output at the maximum optical power. Thus, the optical power of the return light Lr1 becomes relatively smaller than the optical power of the noise light.

In this case, even if the optical power of the return light Lr1 is not equal to or greater than the threshold value, the controller 110 may erroneously determine whether or not the transmission line is cut based on the optical power of the noise light. In order to avoid such an erroneous determination, the OSC light Lo1 is output with the maximum optical power. Thus, the controller 110 can detect the occurrence of the transmission line disconnection based on the return light Lr1 having the optical power equal to or higher than the threshold value. When the controller 110 detects the occurrence of the transmission line disconnection, the controller 110 instructs the ASE light source 105 to stop the output of the pseudo light Pw1 and requests the optical amplifier 103 to shut down. As a result, the ASE light source 105 stops outputting the pseudo light Pw1, and the optical amplifier 103 shuts down.

As a result, although the OSC light Lo1 is output from the optical transmission device 100 alone, since the optical power is small, safety in the recovery operation of the optical transmission line T1 is ensured as compared with the case where the multiplexed light Mx1 is output from the optical transmission device 100. That is, the restoration work is performed safely. As described above, the controller 110 may stop the output of the OSC light Lo1.

Referring back to FIG. 2, when the OSC light Lo1 and the OSC light Lo2 communicate with each other, the controller 110 waits until its own line rises (step S9: NO). That is, the controller 110 waits until the optical transmission line T1, which is its own line, rises. Similarly, the controller 210 waits until the optical transmission line T2, which is its own line, rises.

When the line under the controller 110 is activated (step S9: YES), the controller 110 adjusts the gains of the optical amplifiers 103 and 104 (step S10). More specifically, the controller 110 adjusts the gains of the optical amplifiers 103 and 104 based on the span loss of the optical transmission lines T1 and T2. Thus, the optical amplifiers 103 and 104 are adjusted to have gains suitable for the transmission of the WDM signal lights Lw1 and Lw2, respectively. As described above, the controller 110 can measure the span loss of the optical transmission line T1 based on the optical power of the optical light output from the optical transmission device 100 to the optical transmission line T1 and the optical power of the reflected light.

When the gains of the optical amplifiers 103 and 104 are adjusted, the controller 110 switches the output from the optical transmission device 100 (step S11), and the controller 210 monitors the OSC light and the like until the loss of the OSC light and the like (LOL: Loss of Light) is detected (steps S12 and S13: NO). Specifically, as shown in FIG. 3E, if the multiplexed light Mx1 is output from the optical transmission device 100 without occurrence of a transmission line disconnection, the controller 110 switches the output of the multiplexed light Mx1 to the output of the WDM signal light Lw1 as shown in FIG. 3F. The controller 210 also switches the output of the multiplexed light Mx2 to the output of the WDM signal light Lw2, as in the controller 110.

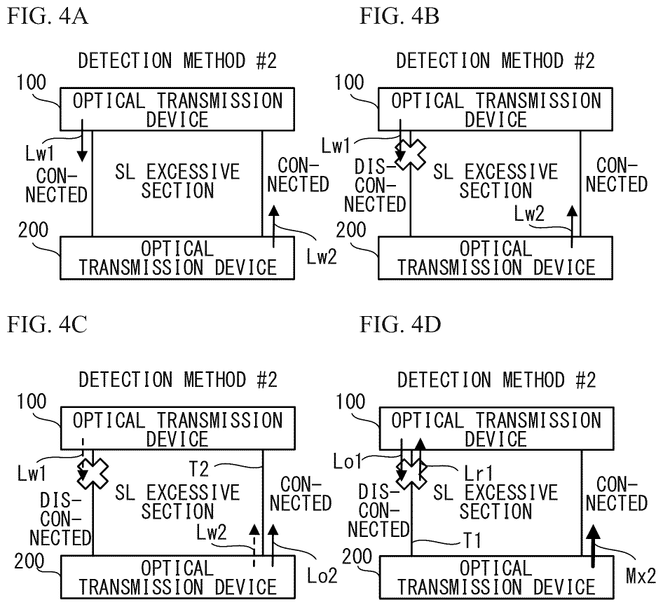

When the controller 110 switches the output of the multiplexed light Mx1 to the output of the WDM signal light Lw1, the controller 110 switches the first detection method to the second detection method as shown in FIG. 4A. The second detection method is different from the first detection method in that the controller 210 monitors the OSC light Lo1 and the WDM signal light Lw1, and detects a transmission line break of the optical transmission line T1 when detecting a light break of either or both of the OSC light Lo1 and the WDM signal light Lw1. The loss of light corresponds to a state where the optical power is lower than the reference value or a state where the OSC light Lo1 and the WDM signal light Lw1 are not detected at all. The second detection method includes a method in which the controller 110 monitors the OSC light Lo2 and the WDM signal light Lw2, and detects a transmission line break of the optical transmission line T2 when detecting a light break of either or both of the OSC light Lo2 and the WDM signal light Lw2.

When the first detection method is switched to the second detection method, the controller 110 reduces the optical power of the OSC light Lo1 to an optical power that suppresses the occurrence of XPM (Cross Phase Modulation) between the OSC light Lo1 and the WDM signal light Lw1. As a result, the optical power of the OSC light Lo1 is reduced to a level lower than the maximum optical power.

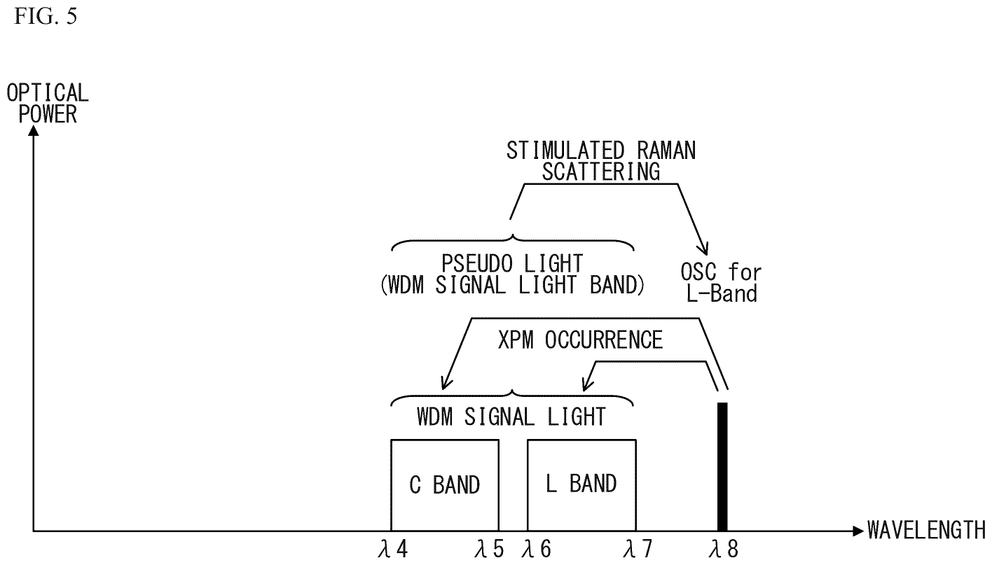

If the optical power of the OSC light Lo1 is maintained at the maximum optical power and the optical power of the OSC light Lo1 is as large as the maximum optical power as shown in FIG. 5, there is a possibility that XPM is generated between the OSC light Lo1 and the WDM signal light Lw1 due to a power change caused by the ON/OFF of the OSC light Lo1, and a transmission error of the WDM signal light Lw1 occurs.

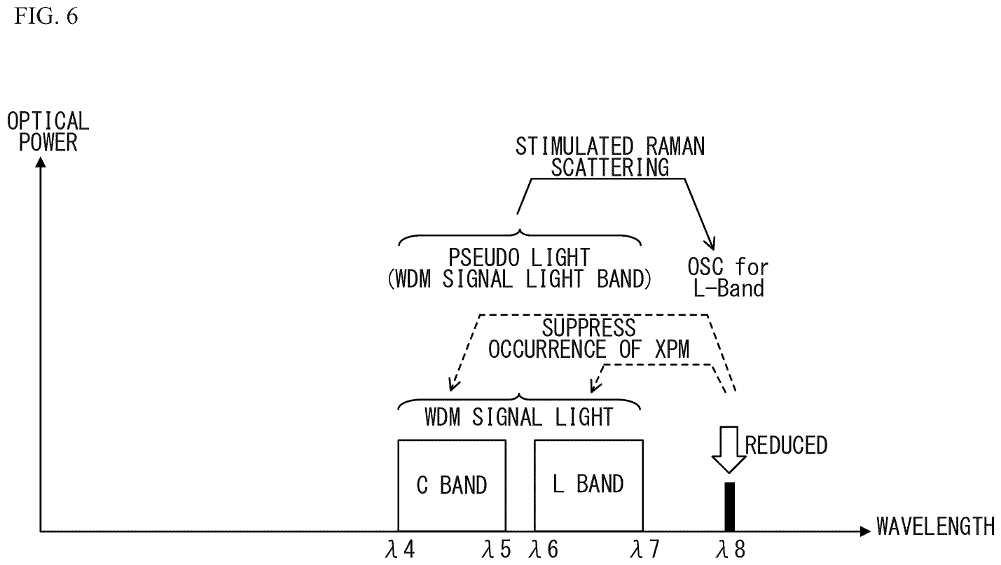

Therefore, when the first detection method is switched to the second detection method, the controller 110 reduces the optical power of the OSC light Lo1 as shown in FIG. 6. Thus, the occurrence of XPM is suppressed, and the signal error of the WDM signal light Lw1 caused by the OSC light Lo1 is avoided. In this way, adverse effects (e.g., transmission errors) due to the nonlinear effect such as XPM caused by the OSC light Lo1 are suppressed.

As shown in FIGS. 5 and 6, the wavelength λ8 of the OSC light Lo1 is longer than the longest wavelength λ7 of the pseudo light Pw1. Therefore, as described above, when the multiplexed light Mx1 propagates through the optical transmission line T1, stimulated Raman scattering occurs, the optical power of the pseudo light Pw1 included in the multiplexed light Mx1 transits to the OSC light Lo1, and the optical power of the OSC light Lo1 increases.

Referring back to FIG. 2, when the controller 210 detects the optical disconnection of the OSC light or the like (step S13: YES), the controller 110 executes the processing of step S5 again. For example, as shown in FIG. 4B, when a transmission line break occurs in the optical transmission line T1, the controller 210 detects the optical break of the WDM signal light Lw1 to detect the transmission line break of the optical transmission line T1.

More specifically, when a transmission line break occurs in the optical transmission line T1, the controller 210 detects a light break of the WDM signal light Lw1. The controller 210 may detect the optical disconnection of the OSC light Lo1. When the optical disconnection is detected, the controller 210 requests the OSC input/output unit 202 to output the OSC light Lo2 including an instruction to shut down the optical amplifier 103 of the optical transmission device 100. As a result, as shown in FIG. 4C, the OSC input/output unit 202 outputs the OSC light Lo2 including an instruction to shut down the optical amplifier 103. As a result, the optical amplifier 103 is shut down. After the OSC input/output unit 202 outputs the OSC light Lo2, the controller 210 waits for a predetermined time and then shuts down the optical amplifier 203. The predetermined time is set to, for example, a time long enough for an instruction to shut down the optical amplifier 103 to be transmitted to the optical transmission device 100 without fail.

The optical amplifiers 103 and 203 may be shut down by a method different from the above method. For example, when detecting the optical disconnection of the OSC light Lo1, the controller 210 notifies the optical transmission device 100 of the optical disconnection of the OSC light Lo1 based on the FEFI (Far End Fault Indication). The FEFI is a protocol for notifying the opposite device of the optical disconnection by using the other of the OSC lights Lo1 and Lo2 when either one of the OSC lights Lo1 and Lo2 becomes the optical disconnection. As shown in FIG. 4C, the controller 210 shuts down the optical amplifier 203 after notifying the optical disconnection of the OSC light Lo1 with the OSC light Lo2. When the controller 210 shuts down the optical amplifier 203, the input of the WDM signal light Lw2 to the optical amplifier 104 is stopped. Thus, the controller 110 can detect the optical disconnection of the WDM signal light Lw2. The controller 110 shuts down the optical amplifier 103 based on the notification of the optical disconnection of the OSC light Lo1 and the detection of the optical disconnection of the WDM signal light Lw2.

Thereafter, the controller 110 executes the processing of step S5 again, and as shown in FIG. 4D, the controller 110 switches the second detection method to the first detection method, and returns the optical power of the OSC light Lo1 to the maximum optical power. Since the output of the WDM signal light Lw1 is stopped from the state in which the WDM signal light Lw1 is output, the OSC light Lo1 is output from the optical transmission device 100 alone. Therefore, when a transmission line break occurs in the optical transmission line T1, the return light Lr1 is input to the optical transmission device 100.

Referring back to FIG. 2, in the processing of step S2, when the optical transmission line T1 is not in the span loss excessive section (step S2: NO), the controller 110 requests the OSC input/output unit 102 to output the OSC light Lo1 (step S14). When the span loss is not excessive, the OSC input/output unit 102 may output the OSC light Lo1 with the maximum optical power or with an optical power smaller than the maximum optical power. Since the span loss is not excessive, the OSC light Lo1 can reach the optical transmission device 200 from the optical transmission device 100.

When the OSC light Lo1 is output, the controller 210 monitors the OSC light and the like (step S15). That is, the controller 210 monitors the OSC light Lo1 and the WDM signal light Lw1, and determines whether or not a transmission line disconnection occurs based on the second detection method described above. When the OSC light or the like is monitored, the controller 110 adjusts the gains of the optical amplifiers 103 and 104 (step S16). More specifically, the controller 110 adjusts the gains of the optical amplifiers 103 and 104 based on the span loss of the optical transmission line T1.

Thus, the optical amplifiers 103 and 104 are adjusted to have gains suitable for transmission of the WDM signal lights Lw1 and Lw2, respectively. The controller 110 can measure the span loss of the optical transmission line T1 based on the attenuation amount of the optical power of the OSC light Lo1 output from the optical transmission device 100 to the optical transmission line T1. The attenuation amount of the optical power of the OSC light Lo1 is notified to the optical transmission device 100 via the OSC light Lo2 output from the optical transmission device 200.

When the gain of the optical amplifiers 103 and 104 is adjusted, the controller 110 switches the output from the optical transmission device 100 (step S17), and the controller 210 stands by until the loss of the OSC light or the like is detected (step S18: NO). When the controller 210 detects the optical disconnection of the OSC light or the like (step S18: YES), the controller 110 executes the processing of step S16 again.

As described above, according to the first embodiment, when a transmission line disconnection occurs in the optical transmission line T1 before the OSC light Lo1 and the OSC light Lo2 are communicated between the optical transmission devices 100 and 200, for example, the output of the pseudo light Pw1 from the optical transmission device 100 is stopped based on the return light Lr1 of the OSC light Lo1. This ensures safety when the optical transmission line T1 is restored. When a transmission line disconnection occurs in the optical transmission line T2, the output of the pseudo light Pw2 from the optical transmission device 200 is stopped based on the return light (not shown) of the OSC light Lo2. This ensures safety when the optical transmission line T2 is restored.

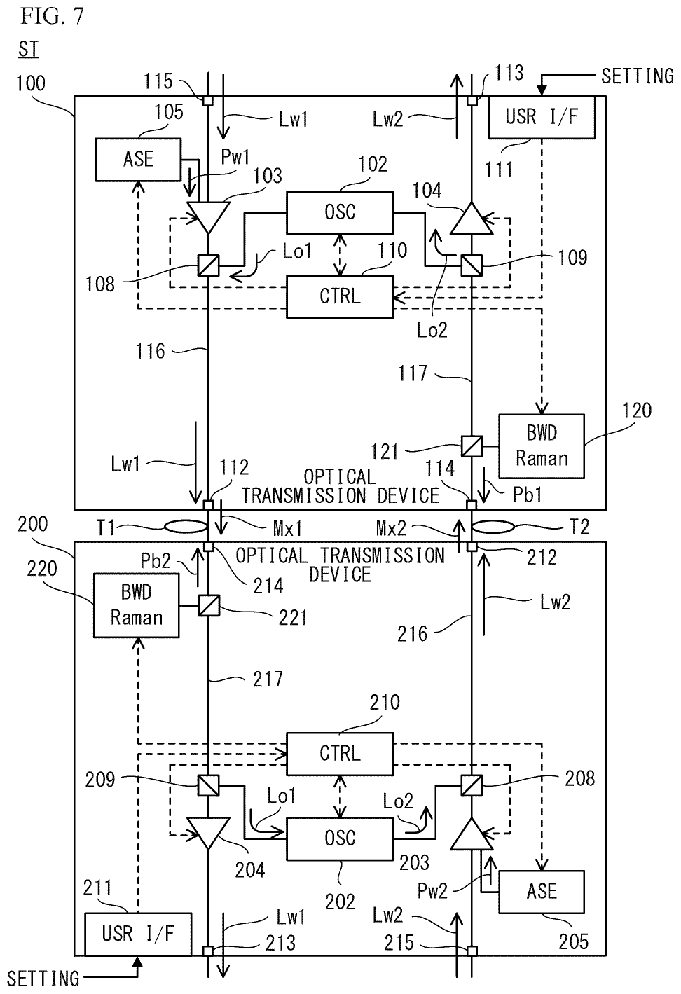

(Second Embodiment) A second embodiment will be described with reference to FIGS. 7 to 10. The same reference numerals are given to the same configurations and processes as those of the optical transmission devices 100 and 200 described in the first embodiment, and a detailed description thereof will be omitted.

First, as shown in FIG. 7, the optical transmission device 100 includes a backward pumping Raman amplifier (denoted as BWD Raman in FIG. 7) 120. The backward pumping Raman amplifier 120 is connected to the optical transmission path 117 via a WDM coupler 121. The optical transmission device 200 also includes a backward pumping Raman amplifier 220. The backward pumping Raman amplifier 220 is connected to the optical transmission path 217 via a WDM coupler 221. The backward pumping Raman amplifiers 120 and 220 are examples of backward pumping light sources.

The backward pumping Raman amplifier 120 outputs a backward pumping light Pb1. The backward pumping light Pb1 propagates in the optical transmission line T2 in the direction opposite to the direction in which the multiplexed light Mx2 and the WDM signal light Lw2 propagate in the optical transmission line T2. The backward pumping light Pb1 Raman-amplifies the multiplexed light Mx2 by using stimulated Raman scattering in the optical transmission line T2. Thus, the optical power of the OSC light Lo2 included in the multiplexed light Mx2 is further improved as compared with the case where the pseudo light Pw2 is used alone.

Similarly, the backward pumping Raman amplifier 220 outputs the backward pumping light Pb2. The backward pumping light Pb2 propagates in the optical transmission line T1 in the direction opposite to the direction in which the multiplexed light Mx1 and the WDM signal light Lw1 propagate in the optical transmission line T1. The backward pumping light Pb2 Raman-amplifies the multiplexed light Mx1 by using stimulated Raman scattering in the optical transmission line T1. Thus, the optical power of the OSC light Lo1 included in the multiplexed light Mx1 is further improved as compared with the case where the pseudo light Pw1 is used alone.

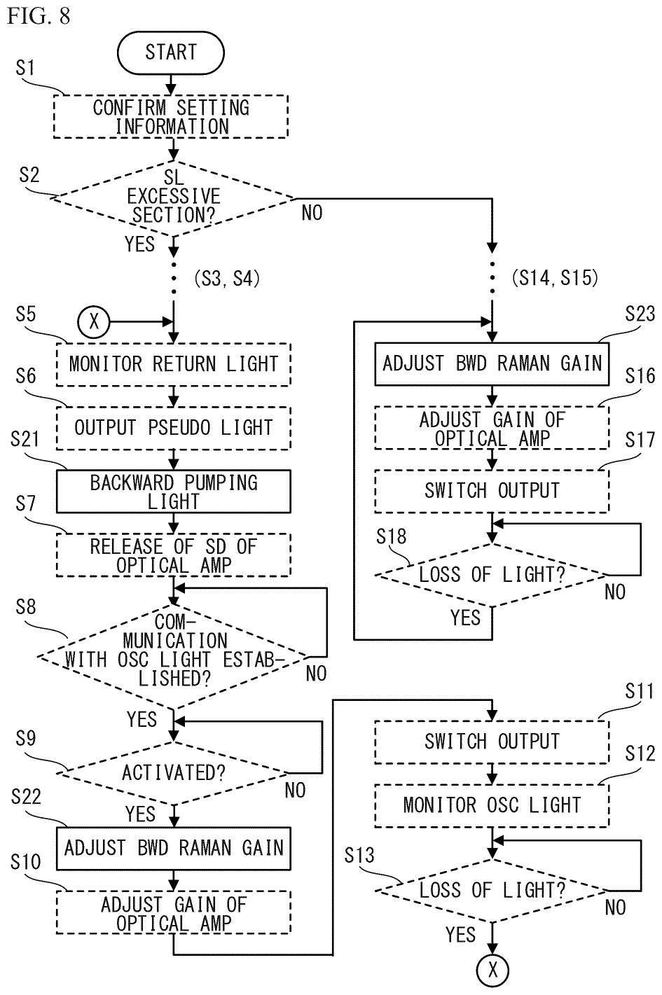

The operation of the optical transmission device 100 will be described. The operation of the optical transmission device 200 is basically similar to that of the optical transmission device 100, and therefore, a detailed description thereof will be omitted. As shown in FIG. 8, after the processing of step S6 described in the first embodiment and before the processing of step S7, the controller 110 instructs the backward pumping Raman amplifier 120 to output the backward pumping light Pb1 (step S21). Thus, the backward pumping Raman amplifier 120 outputs the backward pumping light Pb1.

After the processing of step S9 described in the first embodiment and before the processing of step S10, the controller 110 adjusts the gain of the backward pumping Raman amplifier 120 (step S22). For example, the controller 110 adjusts the gain of the backward pumping Raman amplifier 120 based on the span loss of the optical transmission line T2 notified by using the OSC light Lo2. Similarly, the controller 210 can adjust the gain of the backward pumping Raman amplifier 220 based on the span loss of the optical transmission line T1 notified by using the OSC light Lo1.

Further, the controller 110 adjusts the gain of the backward pumping Raman amplifier 120 after the processing of step S15 described in the first embodiment and before the processing of step S16 (step S23). Similarly, the controller 210 may adjust the gain of the backward pumping Raman amplifier 220.

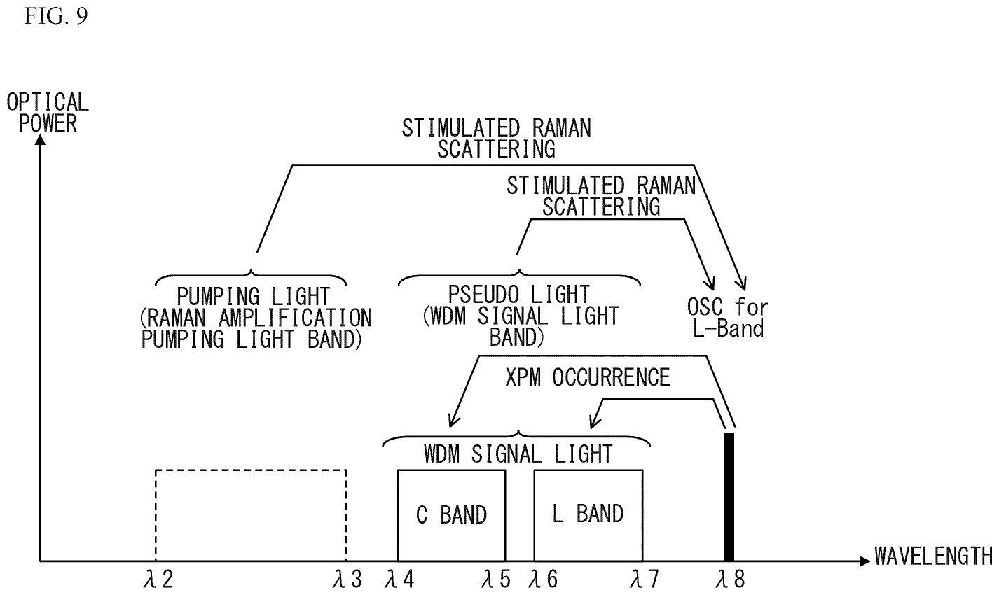

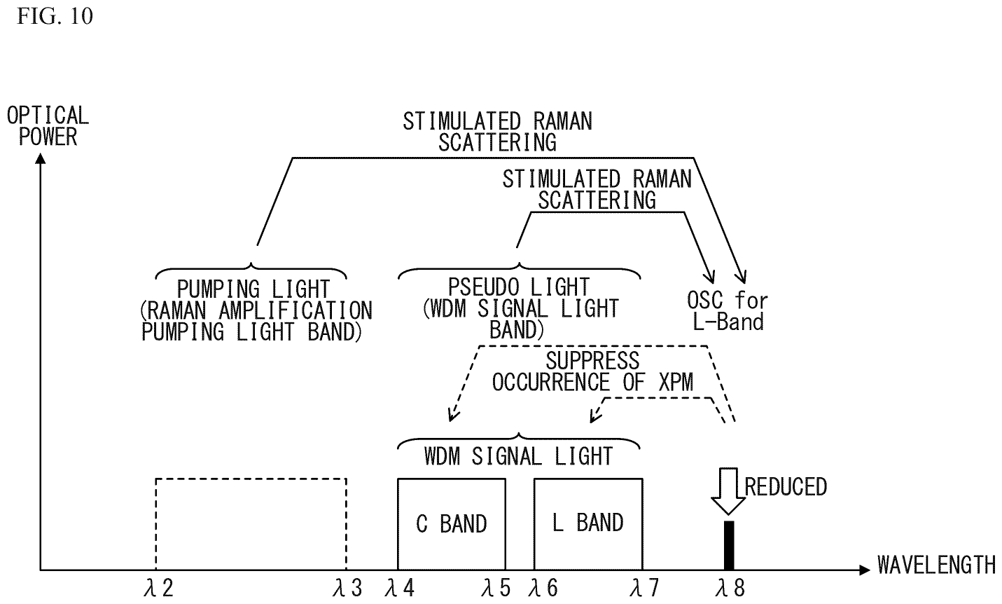

Here, also in the second embodiment, as shown in FIGS. 9 and 10, when the multiplexed light Mx1 propagates through the optical transmission line T1, stimulated Raman scattering occurs, and the optical power of the pseudo light Pw1 included in the multiplexed light Mx1 transits to the OSC light Lo1. This increases the optical power of the OSC light Lo1. In the second embodiment, stimulated Raman scattering based on the backward pumping light Pb1 is also generated, and the optical power of the OSC light Lo1 is increased. When the controller 110 switches the output of the multiplexed light Mx1 to the output of the WDM signal light Lw1 and switches the first detection method to the second detection method, the controller 110 reduces the optical power of the OSC light Lo1 as shown in FIGS. 9 and 10. Thus, the occurrence of XPM is suppressed as in the first embodiment.

As described above, according to the second embodiment, the optical transmission device 100 includes the backward pumping Raman amplifier 120. Thus, the optical power of the OSC light Lo2 is further improved as compared with the case where the pseudo light Pw2 is used alone. Similarly, the optical transmission device 200 includes the backward pumping Raman amplifier 220. Thus, the optical power of the OSC light Lo1 is further improved as compared with the case where the pseudo light Pw1 is used alone. That is, the OSC light beams Lo1 and Lo2 can enjoy not only the effect of stimulated Raman scattering from the pseudo light beams Pw1 and Pw2 but also the effect of stimulated Raman scattering from the backward pumping light beams Pb1 and Pb2 including the wavelength band from the lowest wavelength λ2 to the longest wavelength λ3.

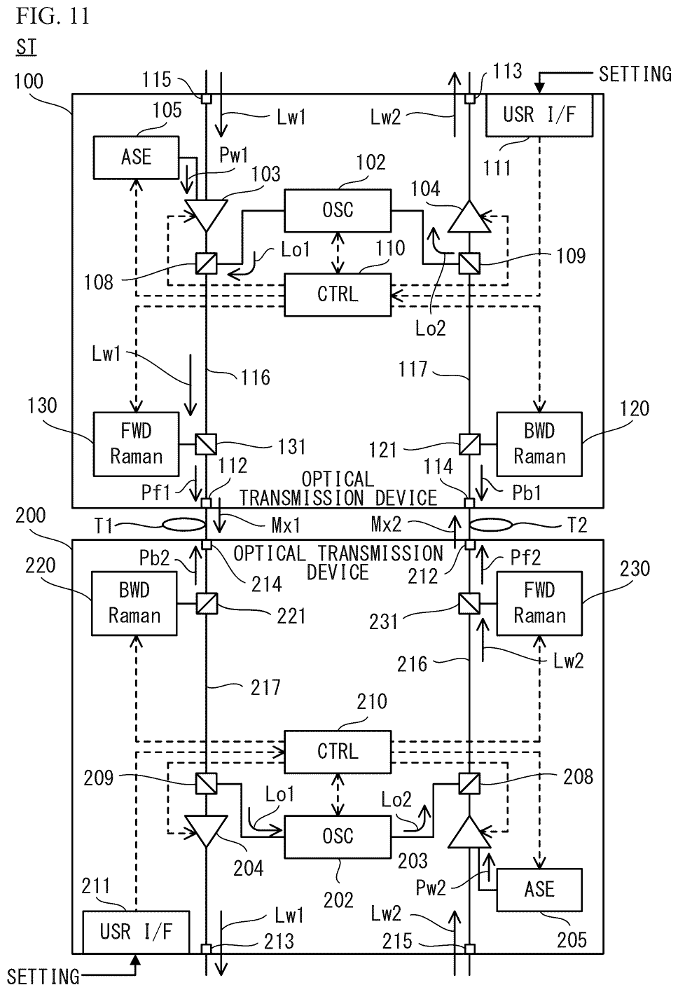

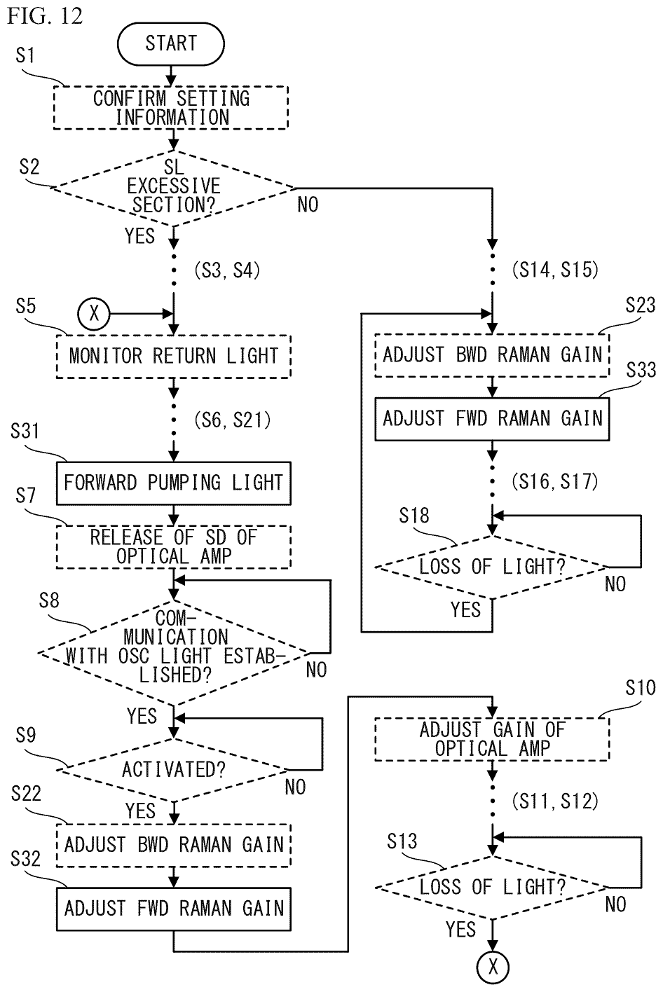

(Third Embodiment) A third embodiment will be described with reference to FIGS. 11 and 12. First, as shown in FIG. 11, the optical transmission device 100 according to the third embodiment is different from the optical transmission device 100 according to the second embodiment. Specifically, the optical transmission device 100 according to the third embodiment further includes a forward pumping Raman amplifier (denoted as FWD Raman in FIG. 11) 130. The forward pumping Raman amplifier 130 is connected to the optical transmission path 116 via a WDM coupler 131.

The optical transmission device 200 according to the third embodiment is different from the optical transmission device 200 according to the second embodiment. Specifically, the optical transmission device 200 according to the third embodiment further includes a forward pumping Raman amplifier 230. The forward pumping Raman amplifier 230 is connected to the optical transmission path 216 via a WDM coupler 231. The forward pumping Raman amplifiers 130 and 230 are examples of forward pumping light sources.

The forward pumping Raman amplifier 130 outputs forward pumping light Pf1. The forward pumping light Pf1 propagates in the optical transmission line T1 in the same direction as the direction in which the multiplexed light Mx1 and the WDM signal light Lw1 propagate in the optical transmission line T1. The forward pumping light Pf1 Raman amplifies the multiplexed light Mx1 by utilizing stimulated Raman scattering in the optical transmission line T1. Thus, the intensity of the OSC light Lo1 included in the multiplexed light Mx1 is further improved as compared with the case where the pseudo light Pw1 and the backward pumping light Pb2 are used in combination.

Similarly, the forward pumping Raman amplifier 230 outputs forward pumping light Pf2. The forward pumping light Pf2 propagates in the optical transmission line T2 in the same direction as the direction in which the multiplexed light Mx2 and the WDM signal light Lw2 propagate in the optical transmission line T2. The forward pumping light Pf2 Raman amplifies the multiplexed light Mx2 by using stimulated Raman scattering in the optical transmission line T2. Thus, the intensity of the OSC light Lo2 belonging to the multiplexed light Mx2 is further improved as compared with the case where the pseudo light Pw2 and the backward pumping light Pb1 are used in combination.

The operation of the optical transmission device 100 will be described. The operation of the optical transmission device 200 is basically similar to that of the optical transmission device 100, and therefore, a detailed description thereof will be omitted. As shown in FIG. 12, after the processing of step S21 described in the second embodiment and before the processing of step S7, the controller 110 instructs the forward pumping Raman amplifier 130 to output the forward pumping light Pf1 (step S31). Thus, the forward pumping Raman amplifier 130 outputs the forward pumping light Pf1.

The controller 110 adjusts the gain of the forward pumping Raman amplifier 130 after the processing of step S22 described in the second embodiment and before the processing of step S10 (step S32). For example, the controller 110 adjusts the gain of the forward pumping Raman amplifier 130 based on the span loss of the optical transmission line T1 notified by using the OSC light Lo2. Similarly, the controller 210 adjusts the gain of the forward pumping Raman amplifier 230 based on the span loss of the optical transmission line T2 notified by using the OSC light Lo1.

Further, after the processing of step S23 described in the second embodiment and before the processing of step S16, the controller 110 adjusts the gain of the forward pumping Raman amplifier 130 (step S33). Similarly, the controller 210 adjusts the gain of the forward pumping Raman amplifier 230.

As described above, according to the third embodiment, the optical transmission device 100 includes the forward pumping Raman amplifier 130. Thus, the optical power of the OSC light Lo1 is further improved as compared with the case where the pseudo light Pw1 and the backward pumping light Pb2 are used in combination. Similarly, the optical transmission device 200 includes a forward pumping Raman amplifier 230. Thus, the optical power of the OSC light Lo2 is further improved as compared with the case where the pseudo light Pw2 and the backward pumping light Pb1 are used in combination. That is, the OSC light beams Lo1 and Lo2 can enjoy not only the effect of stimulated Raman scattering from the pseudo light beams Pw1 and Pw2 and the backward pumping light beams Pb1 and Pb2 but also the effect of stimulated Raman scattering from the forward pumping light beams Pf1 and Pf2 including the wavelength band from the lowest wavelength λ2 to the longest wavelength λ3.

Although the preferred embodiments have been described above in detail, various modifications and changes are possible within the scope of the present disclosure. For example, the optical transmission devices 100 and 200 may include an ILA (In-Line Amplifier) instead of the ROADM. In the above embodiments, the use of both the backward Raman amplifiers 120 and 220 and the use of all the backward Raman amplifiers 120 and 220 and the forward Raman amplifiers 130 and 230 are described as examples, but the present disclosure is not limited to such use. For example, both forward pumping Raman amplifiers 130 and 230 may be utilized without utilizing the backward pumping Raman amplifiers 120 and 220.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An optical transmission system comprising:
a first optical transmission device that transmits an OSC (Optical Supervisory Channel) light to an optical transmission line; and
a second optical transmission device that receives the OSC light from the optical transmission line,
the first optical transmission device including a first controller that detects a transmission line disconnection before communication with the OSC light is established in the optical transmission line, based on a first detection method, and
the second optical transmission device including a second controller that detects a transmission line disconnection after the communication with the OSC light is established in the optical transmission line, based on a second detection method different from the first detection method.

2. The optical transmission system according to claim 1, wherein the first detection method detects the transmission line disconnection before the communication with the OSC light is established in accordance with return light returned by reflection of the OSC light.

3. The optical transmission system according to claim 1, wherein the second detection method detects the transmission line disconnection after the communication with the OSC signal is established in accordance with one of the OSC light and a signal light transmitted from the first optical transmission device to the second optical transmission device.

4. The optical transmission system according to claim 1, wherein the first controller reduces an optical power of the OSC light after the communication with the OSC light is established.

5. The optical transmission system according to claim 3, wherein a wavelength of the OSC light is longer than a wavelength of the signal light.

6. The optical transmission system according to claim 1, wherein
the first optical transmission device further includes a pseudo light source that outputs pseudo light for increasing an optical power of the OSC light based on occurrence of stimulated Raman scattering in the optical transmission line, and
the first controller instructs the pseudo light source to output the pseudo light when the transmission line disconnection before the OSC signal is transmitted is not detected.

7. The optical transmission system according to claim 6, wherein a wavelength of the OSC light is longer than a wavelength of the pseudo light.

8. The optical transmission system according to claim 1, wherein
the second optical transmission device further includes a backward pumping light source that outputs backward pumping light propagating in a second direction opposite to a first direction in which the OSC light propagates in the optical transmission line to the optical transmission line, and
the second controller instructs the backward pumping light source to output the backward pumping light when the transmission line disconnection before the communication is not detected.

9. The optical transmission system according to claim 1, wherein
the first optical transmission device further includes a forward pumping light source that outputs forward pumping light propagating in a first direction in which the OSC light propagates in the optical transmission line to the optical transmission line, and
the first controller instructs the forward pumping light source to output the forward pumping light when the transmission line disconnection before the communication is not detected.

10. The optical transmission system according to claim 1, wherein the first optical transmission device is connected to one end of the optical transmission line, and the second optical transmission device is connected to an other end of the optical transmission line.

11. The optical transmission system according to claim 1, wherein the first controller confirms setting information and selects one of a control for outputting the OSC light at a first optical power and another control for outputting the OSC light at a second optical power smaller than the first optical power based on the setting information before the communication with the OSC light is established.

12. An optical transmission device comprising:
an optical transmission connector through which OSC (Optical Supervisory Channel) light is transmitted to a first optical transmission line;
an optical reception connector through which light propagating in a second direction opposite to a first direction in which the OSC light propagates through the first optical transmission line is received; and
a controller that detects a transmission line disconnection,
the controller detecting the transmission line disconnection in response to a return light returning by reflection of the OSC light before communication with the OSC light is established, and detects, after the communication with the OSC light is established, the transmission line disconnection in accordance with the light received by the optical reception device.
